(19) United States
(12) Patent Application Publication
(10) Pub. No.: US 2013/0264418 A1
(43) Pub. Date: Oct. 10, 2013

(54) METHOD OF MANAGING SYSTEMS ASSOCIATED WITH THE LANDING GEAR OF AN AIRCRAFT

(71) Applicant: MESSIER-BUGATTI-DOWTY, (US)

(72) Inventor: David FRANK, Velizy-Villacoublay (FR)

(73) Assignee: MESSIER-BUGATTI-DOWTY, Velizy-Villacoublay (FR)

(21) Appl. No.: 13/709,572

(22) Filed: Dec. 10, 2012

(30) Foreign Application Priority Data
Dec. 15, 2011 (FR) 11 61712

(51) Int. Cl. B64C 25/30

(52) U.S. Cl. CPC B64C 25/30
USPC 244/102 R

(57) ABSTRACT

The invention relates to a method of managing an aircraft having undercarriages carrying a certain number of braked wheels, the aircraft including:
a system for operating the undercarriages including raising actuators and latching actuators for the undercarriages and the associated hatches;
a braking system including braking actuators for braking the wheels of the aircraft;
at least one control unit for controlling the operation of the undercarriages and the braking; and
at least one maintenance unit for selectively controlling at least some of the actuators of said systems while the aircraft is in a switched-off state during maintenance operations on one or another of the systems.

According to the invention, the method includes the step of activating the maintenance unit while the aircraft is not in the switched-off state in order to use the maintenance unit for actuating actuators connected to the maintenance unit, in particular in the event of a failure of the control unit.

The invention relates to a method of managing systems associated with the landing gear of an aircraft.

### TECHNOLOGICAL BACKGROUND

Aircraft are generally fitted with wheels associated with brakes powered by a braking circuit in order to apply a braking torque selectively to the wheels and thus slow the aircraft down. In a normal mode of braking, one or more braking computers control the application of torque in response to a braking order given by the pilot, e.g. by pressing on brake pedals or by engaging an automatic mode of braking known as “autobrake”. In this mode, the computer implements anti-skid protection.

A second braking computer is generally provided in order to take over from the first braking computer in the event of it failing. This may be referred to as an alternative or an emergency mode of braking. These modes require complex logic that cannot be implemented other than by computers and sophisticated programs.

Furthermore, a parking brake mode is conventionally available for actuating the brakes in order to keep the aircraft stationary when parked, while the aircraft is stopped.

In general, it is desirable for this mode of braking to be provided in a manner that is as simple and as reliable as possible. Thus, on aircraft with hydraulic braking, the parking brake is generally operated by means of a lever arranged in the cockpit so as to be operated by the pilot and that acts via cables and pulleys to control a parking brake valve in order to transmit to the brakes some or all of the pressure from an accumulator arranged in the braking circuit.

The parking brake lever may be used as an ultimate emergency means for braking the aircraft in the event of the normal and alternative modes of braking failing. In this emergency mode, the pilot does not have anti-skid protection and must therefore apply an appropriate amount of force on the lever, while benefiting only from sensations that approximate only. In addition, the same pressure is applied to all of the brakes simultaneously, which does not allow for any differential braking.

The aircraft is also provided with a system for operating the undercarriages to move them between a stowed position and a deployed position. The system includes drive actuators for opening and closing the hatches of the bays that receive the undercarriages, and for causing the undercarriages to be lowered or raised. Latching boxes enable the hatches and the undercarriages to be held in the raised and locked position while the aircraft is in flight.

The aircraft is fitted with an emergency undercarriage-extending system that enables the undercarriages to be released and to be extended under the effect of gravity, in the event of a failure of the undercarriage drive system. The emergency extending system generally includes a lever operated by the pilot, which lever is connected to the latching boxes by cables in order to move the hooks of the latching boxes and thus unlock the undercarriages and the hatches.

Aircraft are sometimes provided with a maintenance unit that makes it possible, when the aircraft is on the ground and stopped, to activate certain functions of the aircraft in order to verify that they are operating properly. The maintenance unit is often the main braking computer, which includes a maintenance test function. The maintenance unit, in particular a unit that is powered by the batteries of the aircraft, makes it possibly only to activate such and such an actuator in application of logic that is extremely simple. Thus, the maintenance unit may for example cause the hatches and the undercarriages to be unlocked so that, when the aircraft is placed on jacks, it is possible to verify that the undercarriages move down properly to their deployed positions.

### OBJECT OF THE INVENTION

The object of the invention is to provide a method for controlling undercarriages and the functions associated therewith, which method provides an emergency mode that is very simple to implement.

### BRIEF SUMMARY OF THE INVENTION

In order to achieve this object, the invention provides a method of managing an aircraft having undercarriages carrying a certain number of braked wheels, the aircraft including:
a system for operating the undercarriages including raising actuators and latching actuators for the undercarriages and the associated hatches;
a braking system including braking actuators for braking the wheels of the aircraft;
at least one control unit for controlling the operation of the undercarriages and the braking; and
at least one maintenance unit for selectively controlling at least some of the actuators of said systems while the aircraft is in a switched-off state during maintenance operations on one or another of the systems.

According to the invention, the method includes the step of activating the maintenance unit while the aircraft is not in the switched-off state in order to use the maintenance unit for actuating actuators connected to the maintenance unit, in particular in the event of a failure of the control unit.

The emergency capability provided by the maintenance unit advantageously replaces mechanical emergency means based on cables and pulleys.

Thus, advantage is taken of the maintenance unit in order to provide emergency actuation of actuators in the undercarriage operating system and in the braking system, in the event of the computer or any other element of the system in question failing and preventing the system from operating normally. There is then no longer any need to provide a specific emergency channel in each of the systems in order to mitigate the failure of the normal channel.

The term “switched-off state” is used to mean that the main avionics systems are switched off, and the engines are not running. In this state, the maintenance unit may be powered by the battery (or by an external network where available), with the remainder of the aircraft remaining unpowered.

### BRIEF DESCRIPTION OF THE DRAWINGS

The invention can be better understood in the light of the following description of the figures of the accompanying drawings, in which:

FIG. 1 is a diagrammatic view of an aircraft for situating the various actuators for braking and for operating the landing gear;

FIGS. 2A and 2B are complementary, being diagrammatic views of a circuit for controlling various actuators of an aircraft, in a particular implementation of the invention;

FIG. 3 is a view showing the principle on which the maintenance unit is activated; and

FIG. 4 is a diagram of another architecture of the invention showing the actuators being actuated by a specific actuation connection.

### DETAILED DESCRIPTION OF THE FIGURES

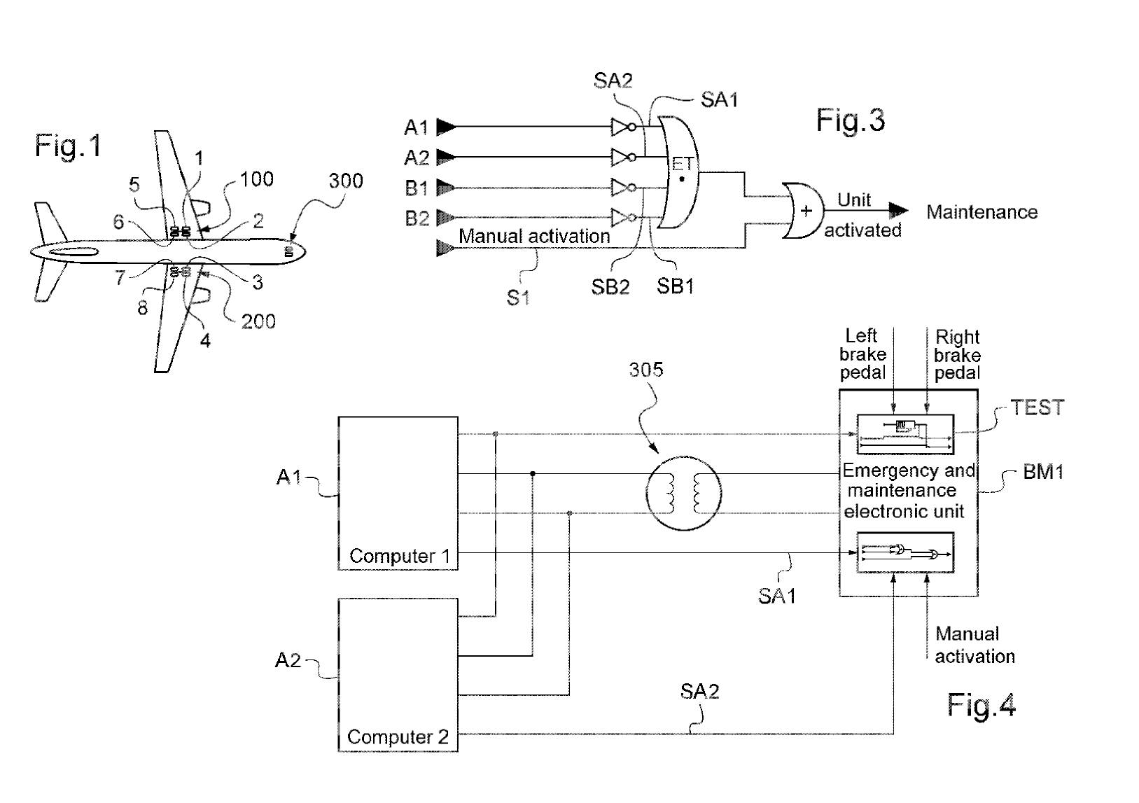

There follows a description of the invention in application to a conventional commercial type aircraft as shown in FIG. 1 that has a left main undercarriage 100, a right main undercarriage 200, and a nose undercarriage 300. The architecture described herein has been selected by way of example, and it is not limiting. Such an architecture is described in detail in document EP 1 739 010 A1.

The left main undercarriage 100 carries four braked wheels fitted with brakes or braking actuators respectively referenced 1, 2, 5, and 6, while the right main undercarriage 200 carries four braked wheels fitted with braking actuators respectively referenced 3, 4, 7, and 8.

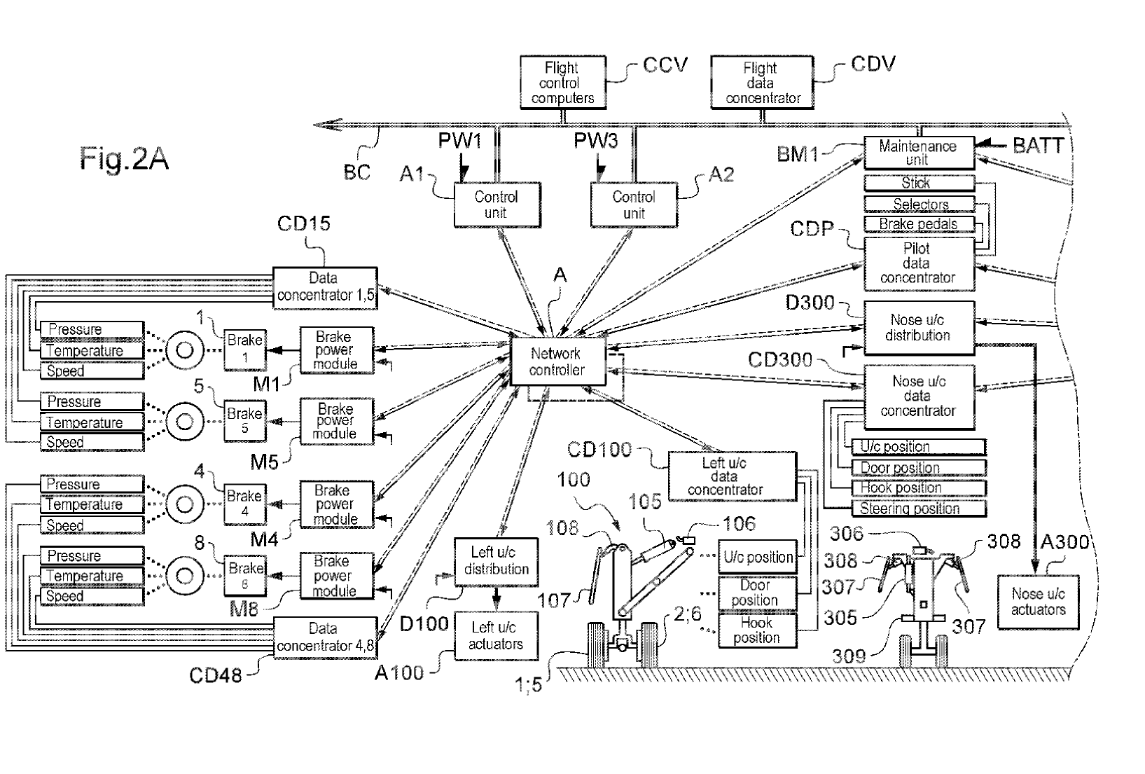

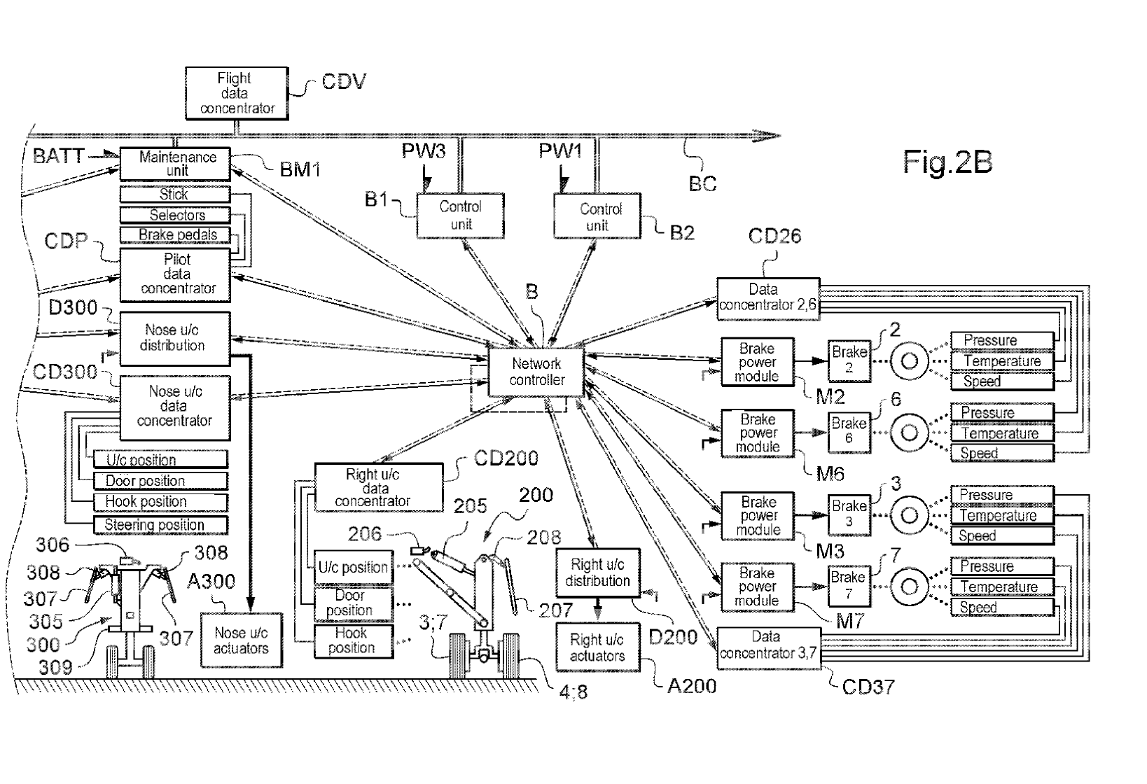

The control architecture of the systems is described in detail below with reference to FIGS. 2A and 2B taken together.

The left main undercarriage 100 is associated for its operation with a raising actuator 105 and with a latching hook 106. Doors 107 provided with operating actuators 108 open and close the bay for receiving the left main undercarriage 100.

Likewise, the right main undercarriage 200 is associated for operation with a raising actuator 205 and with a latching hook 206. Doors 207 provided with operating actuators 208 open and close the bay for receiving the right main undercarriage 200.

Finally, the nose undercarriage 300 is associated for operation with a raising actuator 305 and with a latching hook 306. Doors 307 provided with operating actuators 308 open and close the bay for receiving the nose undercarriage 300. The nose undercarriage 300 also has a steering member 309 (e.g. an actuator with a rack) for swiveling the wheels carried by said undercarriage in order to steer the aircraft on the ground.

Each of the brakes, 1, 2, . . . , 8 is associated with a corresponding power module M1, M2, . . . , M8 serving to transmit to the associated brake power that is proportional to a braking setpoint. With hydraulic brakes, the power module is a servo-valve adapted to transmit to the brake pressure that is proportional to an electrical braking setpoint. With electromechanical brakes, the power module is a converter adapted to transmit to the brake electrical power that is proportional to an electrical braking setpoint.

Likewise, each of the actuators of an undercarriage is associated with a power distribution member serving to power the actuators in response to actuator orders. In the architecture shown, the actuators are grouped together symbolically in boxes referenced A100, A200 and A300 respectively for the left undercarriage actuators, for the right undercarriage actuators, and for the nose undercarriage actuators. The corresponding power distribution members are referenced D100, D200, and D300.

With hydraulic actuators, the distribution member comprises various electrically-controlled valves serving to connect the actuators selectively to a pressure source of the aircraft. With electrical actuators, the distribution member comprises electrically-controlled switches serving to connect the actuators selectively to an electricity source of the aircraft.

Bold-line arrows represent the flow of power towards the brakes and towards the actuators.

The architecture of the invention shown herein serves to manage all of the functions associated with the undercarriages: braking, raising, and steering by acting on the various actuators associated with the undercarriages.

For this purpose, the architecture described herein makes use of a first star communications network A and a second star communications network B, where references A and B are used below to designate the communications network itself or the associated network controller, as can be seen in the figures in the centers of the corresponding communications networks.

The network controller A is connected:
to the power modules M1 and M5 of the outer brakes 1 and 5 of the left main undercarriage 100;
to the power modules M4 and M8 of the outer brakes 4 and 8 of the right main undercarriage 200;
to the distribution member D100 associated with the raising actuators A100 of the left main undercarriage 100; and
to the distribution member D300 associated with the raising and steering actuators A300 of the nose undercarriage 300.

The network controller A is also connected to two control units A1 and A2 that are suitable for generating setpoints or orders for delivering to the power modules and to the distribution members connected to the network controller A. Both control units are permanently active, one of the control units generating the setpoints and orders while being monitored by the other control unit.

The control units A1 and A2 are thus suitable for managing:
the braking of the brakes 1, 5, 4, and 8;
the raising of the left main undercarriage 100 and the raising of the nose undercarriage 300; and
the steering of the wheels of the nose undercarriage 300.

For this purpose, the control units A1 and A2 receive information from data concentrators that are also connected to the communications network A:
a data concentrator CD15 that receives and formats electrical information such as the pressure in the tires of the wheels 1 and 5, the temperature of the brakes 1 and 5, and the speed of rotation of the wheels 1 and 5, this information coming from sensors associated with the brakes 1 and 5;
a data concentrator CD48 that receives and formats electrical information such as the pressure in the tires of the wheels 4 and 8, the temperature of the brakes 4 and 8, and the speed of rotation of the wheels 4 and 8, this information coming from sensors associated with the brakes 4 and 8;
a data concentrator CD100 for the left main undercarriage 100 that receives and formats information concerning the position of the undercarriage (shortening of the shock absorber, angular position of the rocking beam carrying the wheels, . . . ), or state information associated with raising the undercarriage, such as doors opened/closed or latching hooks locked/unlocked;
a data concentrator CD300 for the nose undercarriage 300 that receives and formats information concerning the position of the nose undercarriage (shortening of the shock absorber, angular position of the rocker beam carrying the wheels, . . . ), or state information associated with raising the undercarriage such as doors opened/closed, latching hooks locked/unlocked, and also information concerning the angular position of the wheels of the nose undercarriage; and
a pilot data concentrator CDP that receives and formats signals coming from the brake pedals, from various steering-wheel switches, or indeed from control sticks actuated by the pilot or the copilot (in a variant, it is possible to provide separate data concentrators for the pilot and for the copilot).

In this example, the architecture of the invention has a second star communications network B comprising a network controller that is connected:
to the power modules M2 and M6 of the inner brakes 2 and 6 of the left main undercarriage 100;
to the power modules M3 and M7 of the inner brakes 3 and 7 of the right main undercarriage 200;
to the distribution member D200 associated with the actuators A200 of the right main undercarriage 200; and
to the distribution member D300 associated with the actuators A300 of the nose undercarriage 300.

The network controller B is also connected to two control units B1 and B2 that are suitable for generating setpoints or orders for delivery to the power modules and to the distribution members connected to the network controller B. Both control units are permanently active, one of the control units generating the setpoints and orders while being monitored by the other control unit.

The control units B1 and B2 are thus suitable for managing:
the braking of the brakes 2, 6, 3, and 7;
the raising of the right main undercarriage 200 and the raising of the nose undercarriage 300; and
the steering of the wheels of the nose undercarriage 300.

For this purpose, the control units B1 and B2 receive information from data concentrators that are also connected to the communications network B:
a data concentrator CD26 that receives and formats electrical information such as the pressure in the tires of the wheels 2 and 6, the temperature of the brakes 2 and 6, and the speed of rotation of the wheels 2 and 6, this information coming from sensors associated with the brakes 2 and 6;
a data concentrator CD37 that receives and formats electrical information such as the pressure in the tires of the wheels 3 and 7, the temperature of the brakes 3 and 7, and the speed of rotation of the wheels 3 and 7, this information coming from sensors associated with the brakes 3 and 7;
a data concentrator CD300 of the right main undercarriage 200 that receives and formats information about the position of the undercarriage (shortening of the shock absorber, angular position of the rocker beam carrying the wheels, . . . ) or state information associated with raising the undercarriage such as doors opened/closed, latching hooks locked/unlocked;
the data concentrator CD300 of the nose undercarriage 300; and
the pilot data concentrator CDP.

The control units A1, A2, B1, and B2 are also connected to a communications network BC of the aircraft, e.g. of the asynchronous bidirectional AFDX® type to which other systems of the aircraft are connected such as a flight data concentrator CDV (capable of supplying information such as outside temperature, aircraft speed, . . . ) and various computers, including flight control computers CCD. The bus BC enables the four control units A1, A2, B1, B2 to dialog with one another, to exchange data, and to monitor one another, thereby further increasing the safety of the architecture of the invention.

Furthermore, and according to an essential aspect of the invention, the aircraft has a maintenance unit BM1 that is connected to the networks A and B and to the communications network BC and that is powered by the batteries of the aircraft.

The maintenance unit BM1 is thus connected to the power modules of the brakes and to the distribution modules of the actuators via the networks A and B in order to be capable of actuating the brakes or the raising actuators in a maintenance sequence run by maintenance staff during maintenance operations while the aircraft is stationary on the ground, e.g. in a hangar.

By way of example, the maintenance unit BM1 is used for example while the aircraft is mounted on jacks to unlock the hooks of the hatches, to open the hatch doors, and to unlock the undercarriages, thus causing the undercarriages to extend under the action of gravity. This sequence serves to verify that the actuators for locking the hatches and the undercarriages are operating properly. The maintenance unit also serves to actuate one or the other of the braking actuators in order to test proper operation thereof. For example, the maintenance unit may be wired to simulate pressing on the brake pedals, either simultaneously or differentially.

The energy required for actuating the actuators while the aircraft is stopped may be provided either by an internal source (e.g. an accumulator for hydraulic aircrafts, a battery for electromechanical actuators), or indeed from an external source, e.g. an external generator connected to the aircraft and suitable for supplying it with power even though the engines and the auxiliary power units are stopped. As for the signals needed to perform these sequences, they are returned via the networks A and B to the maintenance unit BM1.

The maintenance unit BM1 is activated by a manual activation signal S1, e.g. coming from a selector situated in the cockpit of the aircraft or in a housing that is accessible to maintenance crews.

According to an essential aspect of the invention, the maintenance unit BM1 may also be activated when the aircraft is not stopped so as to act as an ultimate emergency control unit in the event of the control units A1, A2, B1, B2 all failing. FIG. 3 shows a logic circuit for activation that enables the maintenance unit to be activated automatically when the control units have failed.

In nominal operation, when the control units are functioning, the maintenance unit is kept deactivated by means of discrete signals generated by each of the control units A1, A2, B1, and B2, thereby preventing the maintenance unit from being activated, in application of the logic circuit shown in FIG. 3. It is only when all of the control units have failed, (AND combination of the signals SA1, SA2, SB1, and SB2 coming from the control units in FIG. 3) that the maintenance unit BM1 becomes active and that can then take the place of the control unit to control the associated actuators. In the event that the maintenance unit is not activated even though all of the control units have failed (for example if one of the signals SA1, SA2, SB1, and SB2 is wrongly generated even though the corresponding control unit is not working), then the pilot still has available the resource of manually activating the maintenance unit by operating the corresponding selector in order to be able to actuate the actuators in question.

In practice, the signals SA1, SA2, SB1, and SB2 are output from NOT gates that invert signals that are generated by the control units so long as they are active.

The signals are all at ground potential (signal=TRUE) so long as the control units are operating nominally. If one of the control units fails, the corresponding signal is no longer connected to ground (signal=FALSE). The associated NOT gate therefore serves to obtain a TRUE signal in the event of the control unit failing.

Naturally, if the aircraft has only one control unit, then the maintenance unit will be activated automatically on receiving a signal indicating that the sole control unit has failed. When the maintenance unit BM1 is activated, it takes over from the control unit, at least for those actuators that can be controlled by means of the maintenance unit BM1.

It should be observed that, in the architecture of the invention, the maintenance unit BM1 can be activated while the aircraft is in use, e.g. while in flight or while taxiing. The energy needed for actuating the actuators is then normally available, since the engines or the auxiliary power units are in operation. Failing that, energy can be taken from the storage members, for example hydraulic accumulators or batteries. The maintenance unit, under battery power, is then available even if the avionics is no longer available.

Thus, the maintenance unit BM1 can be used as a replacement for failed control units, and thus act as an emergency unit enabling essential functions to be implemented (lowering the landing gear, braking the aircraft) even in the event of the control unit failing. The maintenance unit thus represents an additional emergency channel. Where appropriate, it may replace the emergency channels that are normally used.

The maintenance unit BM1 is preferably made using simple electronic components (of the field programmable gate array (FPGA) type, amplifiers), without using microprocessors or memory, thereby guaranteeing a high level of availability. Choosing to make it in this way puts a limit on the functions that the maintenance unit can perform.

According to a particular aspect of the invention, the maintenance unit is activated, even though the control units are operating perfectly, in order to perform functional tests. Thus, and on an order from the control units, predetermined scenarios are executed by the maintenance unit in order to test the equipment connected to the maintenance unit, with it being left to the control unit to acquire the signals from the associated sensors and to compare those signals with the expected results. For example, the predetermined scenarios may be as follows:
braking: circulate an imaginary pressure on the brake pedals, and in particular a differential pressure; and
operating the landing gear: while the undercarriages are deployed and the doors have not yet been reclosed, operating the unlocking actuators of the doors and of the undercarriages.

These tests are in addition to so-called “continuous” tests that verify the validity of the inputs to the control units (open circuit, closed circuit, out of range, consistent input values, . . . ).

The invention is not limited to the above description but on the contrary covers any variant coming within the ambit defined by the claims.

Although the maintenance unit in this example is activated in a situation in which the aircraft is used in response to a failure of the control unit(s), it is also possible to activate the maintenance unit while the control units are operating normally, e.g. in order to perform a test sequence using the maintenance unit.

Although in the example described it is stated that the maintenance unit BM1 sends control signals to the power modules and to the distribution members via the communications networks as conventionally used by the control units, this is not limiting, and it is also possible to choose to connect the maintenance unit BM1 to the power modules and to the distribution members via specific connections that do not pass via the networks used by the control units, thereby segregating the actuation system controlled by the maintenance unit BM1. The network might be unavailable when the aircraft is not in operation or when the communications network has failed. It would then be advantageous to make provision for specific connections to enable the maintenance unit to operate even though the network is not operating.

Such segregation can be taken further by providing segregated actuation channels in the power modules and in the distribution members. For example, when controlling a hydraulic distribution valve to power an actuator, provision may be made for said valve to have a second solenoid that is powered solely by the maintenance unit in order to control the valve, independently of a first solenoid that is powered by the control unit. If the actuator is an electromechanical actuator provided with a motor, the motor may be provided with two windings, with one of the windings being powered under the control of the control unit and the other under the control of the maintenance unit.

Similarly, rather than make the signals from the sensors pass via data concentrators connected to digital networks, provision could be made for specific connections between the sensors and the maintenance unit, e.g. parallel analog connections, thereby further contributing to segregating the actuation system controlled by the maintenance unit BM1. Such an arrangement is shown in FIG. 4 in which there can be seen the control units A1 and A2 together with the maintenance unit BM1. This figure shows diagrammatically the two windings of the actuator (e.g. the actuator 305 for operating the nose undercarriage), one of the windings being powered by the control units A1 and A2, and the other being powered directly by the maintenance unit, via specific power supply channels. In addition, the sensor signals that might be necessary for operating said actuators are delivered to the maintenance unit by specific analog connections.

Furthermore, although in the example shown it is stated that the maintenance unit BM1 is for enabling certain landing-gear operating actuators or certain braking actuators to be actuated, the maintenance unit may be entrusted with actuating other actuators, such as for example, in a military transport airplane, actuating the unlocking of the cargo door at the rear of the fuselage, thereby enabling it to be opened using the maintenance unit both when the aircraft is stationary and also when it is in flight.

Finally, although it is stated that the maintenance unit BM1 is powered by the batteries of the aircraft, it could also be powered by the power bus of the aircraft or indeed by an external power supply when the aircraft is parked.

What is claimed is:

1. A method of managing an aircraft having undercarriages carrying a certain number of braked wheels, the aircraft including:
a system for operating the undercarriages including raising actuators and latching actuators for the undercarriages and the associated hatches;
a braking system including braking actuators for braking the wheels of the aircraft;
at least one control unit for controlling the operation of the undercarriages and the braking; and
at least one maintenance unit for selectively controlling at least some of the actuators of said systems while the aircraft is in a switched-off state during maintenance operations on one or another of the systems;
wherein the method includes the step of activating the maintenance unit while the aircraft is not in the switched-off state in order to use the maintenance unit for actuating actuators connected to the maintenance unit, in particular in the event of a failure of the control unit.

2. A method according to claim 1, wherein the maintenance unit is activated in response to at least:
a manual activation order; and/or
a signal coming from a control unit indicating that the control unit has failed.

3. A method according to claim 1, including the use of a plurality of control units suitable for controlling the operating and braking actuators, in which the maintenance unit is activated in response at least to:
a manual activation order; and/or
an AND combination of signals coming from all of the control units and indicating that each corresponding control unit has failed.

4. A method according to claim 1, wherein the maintenance unit is powered with the help of the battery of the aircraft.

5. A method according to claim 1, wherein the actuators controlled by the maintenance unit are connected thereby by specific power supply channels.
